(19) United States
(12) Patent Application Publication
(10) Pub. No.: US 2009/0155653 A1
(43) Pub. Date: Jun. 18, 2009

(54) FUEL CELL SYSTEM

(75) Inventors: Stefan Käding, Zerrenthin (DE); Michael Rozumek, Neubrandenburg (DE); Matthias Boltze, Wulkenzin (DE); Markus Bedenbecker, Gauting (DE); Michael Süßl, München (DE); Beate Bleeker, München (DE); Andreas Engl, München (DE); Manfred Pfalzgraf, Herrsching (DE)

Correspondence Address: DICKINSON WRIGHT PLLC, 1875 Eye Street, NW, Suite 1200, WASHINGTON, DC, 20006, US

(73) Assignee: ENERDAY, GMBH, Stockdorf (DE)

(21) Appl. No.: 12/302,436

(22) PCT Filed: Jun. 12, 2007
(86) PCT No.: PCT/DE07/01036

§ 371 Date: Nov. 25, 2008

(30) Foreign Application Priority Data
Jun. 28, 2006 (DE) 10 2006 029 743.1

(51) Int. Cl. H01M 8/04

(52) U.S. Cl. 429/22

(57) ABSTRACT

The invention relates to a fuel cell system comprising a reformer and an afterburner each for reacting at least fuel and an oxidant; and a fuel feeder for supplying the reformer and the afterburner with fuel. It is provided for to particular advantage that at least one flow control valve for controlling the fuel supply is included upstream of at least the reformer or the afterburner. The invention relates furthermore to a motor vehicle having one such fuel cell system.

The invention relates to a fuel cell system comprising a reformer and an afterburner, each for reacting at least fuel and an oxidant; and a fuel feeder for supplying the reformer and the afterburner with fuel.

The invention relates furthermore to a motor vehicle having one such fuel cell system.

Generic systems serve to convert chemical energy into electrical energy. The element central to such systems is a fuel cell which liberates electrical energy by the controlled reaction of hydrogen and oxygen. Popular fuel cell systems are, for example, a proton exchange membrane (PEM) system which can typically be operated at operating temperatures ranging from room temperature to approx. 100° C. Known furthermore are high-temperature fuel cells, for example, solid oxide fuel cell (SOFC) systems which work, for example, in a temperature range of around 800° C.

Conventional fuel cell systems including a reformer, a fuel cell stack and an afterburner often comprise a plurality of pumps as well as several blowers for supplying the individual components of the fuel cell system with fuel and oxidant respectively. Because of the resulting high number of components such system are expensive to produce.

German patent DE 103 60 458 A1 furthermore discloses a generic fuel cell system with a reduced number of components for the fuel supply. However, despite the cost savings by this system having fewer components its ability to control individual components of the fuel cell system is detrimented because any change in the flow provided for fuel and oxidant delivery automatically effects all components.

It is thus an object of the present invention to sophisticate the generic fuel cell system and a motor vehicle having such a fuel cell system so that a cost-effective fuel cell system can now be made available simultaneously permitting good control.

This object is achieved by the fuel cell system as it reads from claim 1 and by the motor vehicle as it reads from claim 8.

Advantageous aspects and further embodiments of the invention read from the dependent claims.

The fuel cell system in accordance with the invention is based on generic prior art in that at least one flow control valve for controlling the fuel supply is included upstream of at least the reformer or the afterburner. This now makes it possible to do away with at least one fuel feeder in thus reducing the costs of producing the fuel cell system. At the same time, despite these savings, it is now possible to control the supply of fuel to the individual components of the fuel cell system each independent of the other, depending on the mode of operation required.

The fuel cell system in accordance with the invention can be further sophisticated to advantage in that the at least one flow control valve for controlling the fuel supply is included upstream of the afterburner, and in that no flow control valve is provided in the fuel supply line to the reformer. This now makes it possible to save at least one valve in the fuel supply line of the reformer in thus further reducing the costs of the fuel cell system. Since the afterburner features a lower fuel consumption than the reformer, supply of the reformer is thus always assured, a relatively low feed to the afterburner being achievable by control of the corresponding flow control valve.

As an alternative, the fuel cell system in accordance with the invention can be configured so that at least one flow control valve for controlling the fuel supply is included upstream of the reformer and the afterburner respectively. In this embodiment, unlike the previous, an additional flow control valve is needed, this embodiment, however, permitting even better control of the fuel cell system.

In one preferred embodiment of the fuel cell system in accordance with the invention it is furthermore provided for that an oxidant feeder is provided for supplying the reformer and the afterburner with oxidant, in thus achieving the same cost savings as with the fuel feeder, since at least one oxidant feeder can be eliminated.

Further savings materialize from the fact that the oxidant feeder is suitable to supply furthermore a fuel cell stack with cathode feed air in thus doing away with the need for a separate oxidant feeder for supplying the fuel cell stack which again makes for cost savings.

Furthermore, the fuel cell system in accordance with the invention can be sophisticated in that included downstream of the at least one flow control valve is a sensor for closed loop control of the flow control valve by an electronic controller. Supplying several components of the fuel cell system by just a single fuel feeder now makes it possible that any change in the mode of operation of a component automatically effects the fuel supply of the other components because of the pressure in the fuel consumption rising or falling. To counteract this effect the means as described above are included to ensure precise closed loop control of each component.

It is in particular provided for that the sensor is a flow sensor.

In addition, the invention defines a motor vehicle including one such fuel cell system in accordance with the invention, the vehicle featuring the corresponding advantages.

A preferred embodiment of the invention will now be detailed with reference to the attached drawings by way of example, in which:

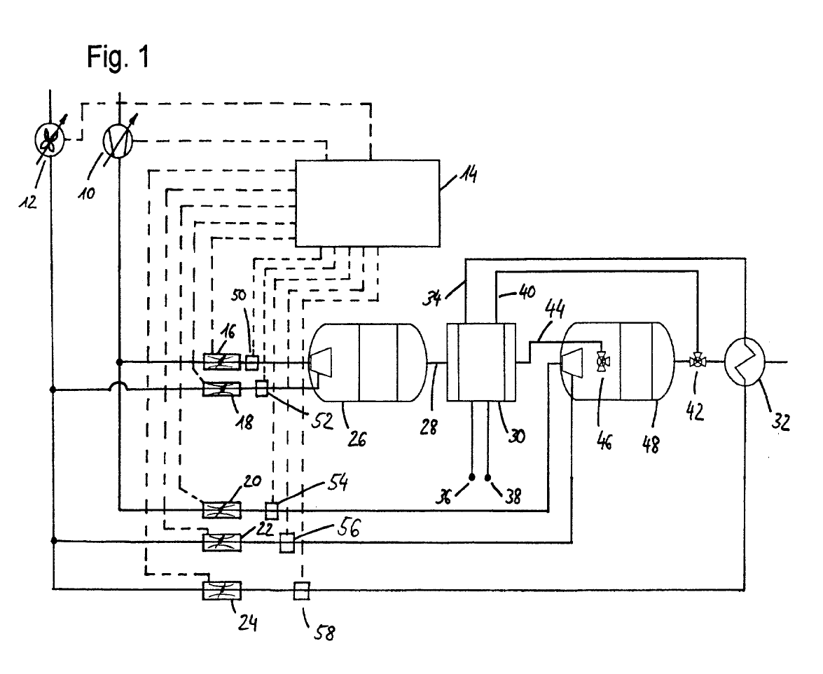

FIG. 1 is a single-line diagram of a first aspect as an example of the fuel cell system in accordance with the invention; and

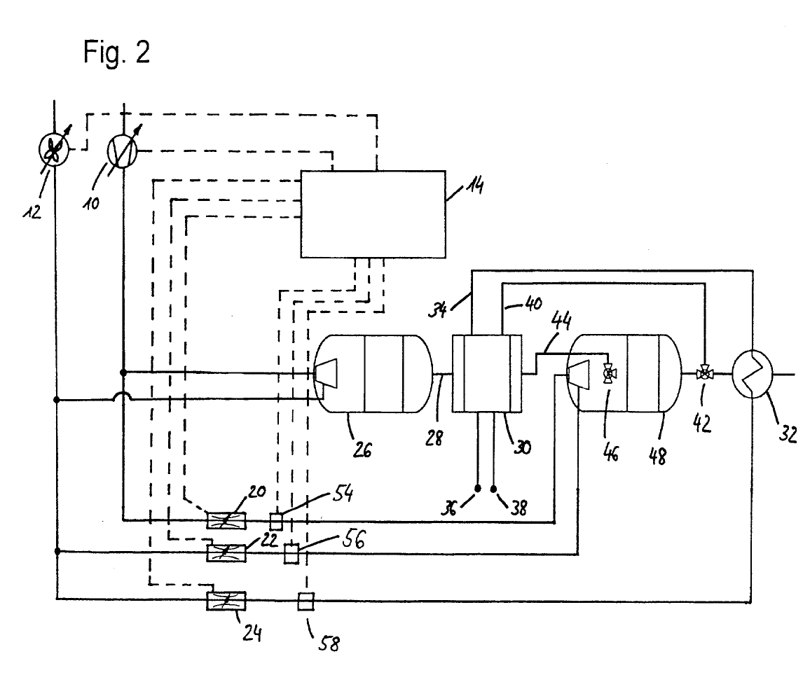

FIG. 2 is a single-line diagram of a second aspect as an example of the fuel cell system in accordance with the invention.

Referring now to FIG. 1 there is illustrated a single-line diagram of a first aspect as an example of the fuel cell system in accordance with the invention. The fuel cell system comprises a fuel feeder 10 and an oxidant feeder 12, the flow of which can be varied each separate from the other by means of an electronic controller 14. All broken lines in the FIGs. represent control or sensing wiring. Branching off from the output of the fuel feeder 10 and oxidant feeder 12 are supply lines each including a flow control valve 16-24 activated by the electronic controller 14. In this case supply line denotes particularly a supply line beginning at one point as of which the line is assignable dedicated for the supply of a certain component of the fuel cell system. It is in this sense that a reformer 26 of the fuel cell system receives a supply of fuel, e.g. diesel, gasoline or natural gas via the fuel feeder 10 and the flow control valve 16. Furthermore, oxidant e.g. air can be fed to the reformer 26 via the oxidant feeder 12 and the flow control valve 18. The fuel and the oxidant fed to the reformer 26 are reacted into reformate 28 which is supplied to a fuel cell stack 30. The fuel cell stack 30 consists of the individual fuel cells stacked and electrically circuited in series. The reformate 28 generated in the reformer 26 gains access to an anode of the individual fuel cells of the fuel cell stack 30. A cathode of the fuel cells of the fuel cell stack 30 receives cathode feed air 34 as the oxidant via the oxidant feeder 12, flow control valve 24 and a heat exchanger 32. Together with the feed of the reformate 28 and cathode feed air 34 the individual fuel cells of the fuel cell stack 30 generate electrical energy in a manner as is known generally which can be picked off across the electric terminals 36 and 38 as a voltage. The cathode exhaust air 40 flows from the fuel cell stack 30 to a mixer 42 and an anode exhaust gas 44 is supplied to a mixer 46 of an afterburner 48. Also available for supply to the afterburner 48 via the fuel feeder 10 and flow control valve 20 is fuel. In a similar manner oxidant is supplied to the afterburner 48 via the oxidant feeder 12 and flow control valve 22. The mixture of fuel and oxidant can be optionally mixed with the anode exhaust gas 44 by means of the mixer 46. The hot exhaust gases of the afterburner 48 are mixed in the mixer 42 with the cathode exhaust air 40 leaving the fuel cell stack 30. The resulting mixture streams through the heat exchanger 32 to preheat the cathode feed air 34. For closed loop control of the feed of fuel and oxidant the flow control valves 16-24 are each followed by sensors 50-58 electrically coupled to the electronic controller 14, i.e. arranged at the output of the flow control valves 16-24. The sensors 50-58 may sense pressure or flow in furnishing a resulting signal for closed loop control of the flow control valves 16-24 to the electronic controller 14. Coriolis mass flow sensors, vortex counter flow sensors or active pressure flow sensors are all useful as the flow sensors.

In operation of the fuel cell system the supply of fuel or oxidant to the reformer 26, afterburner 48 and fuel cell stack 30 is optionally variable, by suitably setting the flow of the corresponding fuel feeder 10 or oxidant feeder 12 and the flow of the corresponding flow control valves 16-24 by means of the electronic controller 14. For this purpose the electronic controller 14 determines preferably by means of given tables the activation of the fuel feeder 10, oxidant feeder 12 and the necessary flow of fuel and oxidant to the individual flow control valves 16-24 as required for the wanted mode of operation. Ensuring that the wanted flow to the flow control valves 16-24 is actually attained is made by closed loop control of the flow control valves 16-24 in evaluating the signals as sensed by the sensors 50-58.

Referring now to FIG. 2 there is illustrated a single-line diagram of a second aspect as an example of the fuel cell system in accordance with the invention. The second aspect differs from the first simply by the flow control valves 16 and 18 as well as the assigned sensors 50 and 52 being omitted in thus saving two flow control valves and two sensors in this example aspect. Since the supply of the media (fuel and oxidant) to the reformer 26 is higher than the corresponding supply of media to the afterburner 48, flow control valves 20 and 22 must be included the same as before for supplying the afterburner 48 and the assigned sensors 54 and 56. When the supply of the media to the reformer 26 is signalled to be increased whilst the supply to the afterburner 48 is to remain constant, then in this variant the flow of the fuel feeder 10 and of the oxidant feeder 12 is increased and each flow of the flow control valves 20 and 22 is maintained constant by closed loop control, i.e. by the bore of these flow control valves being reduced. This is done by the electronic controller 14 the same as described in conjunction with the first example aspect in evaluating the signals furnished by the sensors 54 and 56, resulting in an increase in supply of the media of the reformer 26 whilst that of the afterburner 48 is maintained constant.

In a variant different to the example aspects as described above in which the reformer 26 and afterburner 48 is no longer assigned as a sole flow control valve 16, 20 for fuel supply and no longer as a sole flow control valve 18, 22 for oxidant supply, the following variant is possible. For example the reformer 26 or afterburner 48 may also be assigned a plurality of flow control valves for fuel supply and/or a plurality of flow control valves for supply of the oxidant in parallel. For example, it may be of advantage to supply fuel or oxidant to an evaporator or a secondary or tertiary air supply of the reformer 26 and/or of the afterburner 48 via a flow control valve in separate closed loop control.

It is understood that the features of the invention as disclosed in the above description, in the drawings and as claimed may be essential to achieving the invention both by themselves or in any combination.

### LIST OF REFERENCE NUMERALS

10 fuel feeder
12 oxidant feeder
14 electronic controller
16 flow control valve
18 flow control valve
20 flow control valve
22 flow control valve
24 flow control valve
26 reformer
28 reformate
30 fuel cell stack
32 heat exchanger
34 cathode feed air
36 electric terminal
38 electric terminal
40 cathode exhaust air
42 mixer
44 anode exhaust gas
46 mixer
48 afterburner
50 sensor
52 sensor
54 sensor
56 sensor
58 sensor

1. A fuel cell system comprising a reformer and an afterburner each for reacting at least fuel and an oxidant; and a fuel feeder for supplying the reformer and the afterburner with fuel, characterized in that at least one flow control valve for controlling the fuel supply is included upstream of at least the reformer or the afterburner.

2. The fuel cell system of claim 1, characterized in that the at least one flow control valve for controlling the fuel supply is included upstream of the afterburner, and in that no flow control valve is provided in the fuel supply line to the reformer.

3. The fuel cell system of claim 1, characterized in that at least one flow control valve for controlling the fuel supply is included upstream of the reformer and the afterburner respectively.

4. The fuel cell system of claim 1, characterized in that an oxidant feeder is provided for supplying the reformer and the afterburner with oxidant.

5. The fuel cell system of claim 4, characterized in that the oxidant feeder is suitable to supply furthermore a fuel cell stack with cathode feed air.

6. The fuel cell system of claim 1, characterized in that included downstream of the at least one flow control valve is a sensor for closed loop control of the flow control valve by an electronic controller.

7. The fuel cell system of claim 6, characterized in that the sensor is a flow sensor.

8. A motor vehicle having a fuel cell system of claim 1.
